(19) United States
(12) Patent Application Publication
(10) Pub. No.: US 2003/0077092 A1
(43) Pub. Date: Apr. 24, 2003

(54) Image heating apparatus

(75) Inventors: Kenichi Ogawa, Shizuoka (JP); Michihito Yamazaki, Tokyo (JP); Ken Murooka, Shizuoka (JP); Noriaki Tanaka, Shizuoka (JP); Noriyuki Ito, Shizuoka (JP); Yusuke Nakazono, Shizuoka (JP); Hiroyuki Sakakibara, Shizuoka (JP); Akira Kato, Shizuoka (JP); Hisashi Nakahara, Shizuoka (JP); Satoshi Nishida, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/265,623

(22) Filed: Oct. 8, 2002

(30) Foreign Application Priority Data
Oct. 9, 2001 (JP) 2001-311552
Oct. 1, 2002 (JP) 2002-288480

(51) Int. Cl. G03G 15/20

(52) U.S. Cl. 399/328; 399/329

(57) ABSTRACT

The image heating apparatus for heating an image formed on a recording material, comprising a sliding member and a supporting member for holding the sliding member and a pressure member which forms a nip part, wherein a portion of said supporting member which forms the nip part projects from a surface of the sliding member on the nip part side. The image heating apparatus can suppress a decrease in durability of a flexible rotary body.

### BACKGROUND OF THE INVENTION

1. Field of the Invention

The present invention relates to an image heating apparatus suitably used as a heat fixing device mounted in an image forming apparatus such as a copying machine or printer and, more particularly, to an image heating apparatus with a flexible rotary body which comes into contact with a recording material bearing an image.

2. Related Background Art

The present applicant has proposed various heating apparatuses using a flexible rotary body such as a film (e.g., Japanese Patent Application Laid-Open Nos. 63-313182, 1-263679, 2-157878, 4-44075 to 4-44083 and 2001-100556).

In the basic arrangement of the heating apparatus, a heat-resistant film is sandwiched between a heating body such as a ceramic heater and a pressuring member to form a heating nip part. An object to be heated is introduced into the film of the heating nip part and the pressuring member, and clamped and conveyed together with the film. At the heating nip part, heat of the heating body is applied to the object via the film to heat the object. An on-demand type apparatus in which the heating body and film are reduced in heat capacity and equipped with features such as a quick start characteristic and power saving can be constituted. For example, the image heating apparatus can be effectively utilized as a fixing apparatus which heats and fixes an unfixed image (unfixed toner image) formed and born on a recording material in an image forming apparatus such as a printer, facsimile apparatus, or copying machine.

FIG. 7 is a schematic cross-sectional view showing an example of a film heating type heating apparatus. FIG. 8 is a schematic enlarged view showing the heating nip part of the heating apparatus.

A heating body supporting member 1 also serves as a film guide with a substantially semicircular bucket-like cross section. A heating body 3 is fitted, fixed, and held in a slot 1a formed along the longitudinal direction (direction perpendicular to the sheet surface of FIG. 7) of the heating body supporting member 1 at almost the center of the lower surface of the heating body supporting member 1. The heating body 3 is a so-called ceramic heater with a low heat capacity.

A cylindrical (endless) heat-resistant film 2 is fitted on the outside of the heating body supporting member 1 which fixes and holds the heating body 3. The inner circumferential length of the cylindrical film 2 is larger by about 3 mm than the outer circumferential length of the heating body supporting member 1 including the heating body 3. The film 2 is loosely fitted on the outside of the heating body supporting member 1 with a margin in circumferential length.

An elastic pressure roller 4 functions as a pressure member, and is made up of a core metal 4-a and a heat-resistant rubber layer 4-b made of silicone rubber or the like with good mold release properties. The film 2 is sandwiched between the heating body 3 and the pressure roller 4. The film 2 is pressed at a predetermined press force against the elasticity of the pressure roller 4, forming a heating nip part (to be referred to as a fixing nip part hereinafter) with a predetermined width Wn in the conveying direction of the recording material.

In the conventional fixing apparatus, the inner diameter of the cylindrical film 2 is 30 mm, and a width Wk of the heating body 3 in the conveying direction of the recording material is 7.0 mm. The core metal 4-a of the elastic pressure roller 4 has φ 14 mm, and the rubber part 4-b has an outer diameter of φ20 mm and a hardness of 45° (ASKER-C: total weight=5.88 N). The pressure force which forms the fixing nip part is 98.07 N. A fixing nip part width Wn in this state is 6.0 mm.

To reduce the heat capacity of the film 2 and improve the quick start characteristic, the film 2 is formed from a heat-resistant PTFE, PFA, or FEP single layer with a film thickness of 100 μm or less, and preferably 20 μm (inclusive) to 50 μm (inclusive), or a composite layer film prepared by coating an outer surface of polyimide, polyamide-imide, PEEK, PES, PPS, or the like with PTFE, PFA, FEP, or the like. The prior art employs a film prepared by coating the outer surface of a polyimide film with PTFE.

The ceramic heater as the heating body 3 is constituted by applying an electrically resistive material such as Ag/Pd (silver palladium) for a heating member (to be referred to as a resistive heating body hereinafter) 6 on the surface of a heater substrate 5 made of Al₂O₃, AlN, or the like to a thickness of about 15 μm and a width Wt of 1 to 3 mm in the conveying direction of the recording material by screen printing or the like. The resistive heating body 6 is coated with glass, fluoroplastic, or the like as a protective layer 7. A thermistor 8 as a heating body temperature detection element is formed on a surface of the heater substrate 5 opposite to the surface on which the resistive heating body 6 is formed. The thermistor 8 is arranged at a position where it falls within a width at which a minimum recording material can be fed. The surface of the heating body 3 on the protective layer 7 side is a heater surface side on which the film 2 slides with its inner surface in tight contact with the heater surface. The heater exposes its heater surface side downward, and is fitted, fixed, and held in the slot 1a of the heating body supporting member 1.

The pressure roller 4 is rotated and driven by a driving system M at a predetermined peripheral velocity counterclockwise as indicated by the arrow. Following the rotation and driving of the pressure roller 4, the fixing film 2 rotates around the heating body supporting member 1 clockwise as indicated by the arrow while sliding with the inner surface in tight contact with the lower surface of the heating body 3.

By energizing the energization heating body 6 from a feed circuit 14, the temperature of the heating body 3 rapidly rises by heat generated by the resistive heating body 6. The temperature state of the heating body 3 is detected by the thermistor 8. An output from the thermistor 8 is A/D-converted by an A/D converter 11, and input to a control circuit (CPU) 12. Based on this information, a triac 13 performs phase control and wave number control of the AC voltage of the feed circuit 14, thereby controlling the energization power of the heating body 3 to the resistive heating body 6. Accordingly, the temperature of the heating body 3 is controlled to a predetermined fixing temperature.

The pressure roller 4 and film 2 are rotated in the above-described manner, and the heating body 3 is energized and adjusted to a predetermined fixing temperature. In this state, a recording material P bearing an unfixed toner image t is introduced and clamped between the film 2 and the pressure roller 4 at the fixing nip part. The recording material P is conveyed to thermally fix the unfixed toner image t as a permanently fixed image ta onto the recording material P by heat applied from the heating body 3 via the film 2 and the pressure force of the fixing nip part.

Temperature control of the fixing apparatus will be briefly explained with reference to FIG. 9. When the image forming apparatus having the fixing apparatus is kept unoperated for 5 to 6 hours, the fixing apparatus cools down to almost room temperature. The temperature at this time exhibits Ta° C. The temperature Ta is the detection temperature of the thermistor 8 in contact with the heating body 3.

After printing starts, the temperature of the heating body 3 starts rising. Along with the temperature rise, the detection temperature of the thermistor 8 also changes to Tb, Tc . . . C. The heating body 3 rises to a fixing temperature Td necessary to permanently fix an unfixed toner image time e immediately before the recording material P reaches the fixing nip part. As the next step after the heating body 3 rises to the fixing temperature Td, a recording material is fed to form an image.

As shown in FIG. 10, a thermistor 15 was adhered to the recording material P to monitor a temperature applied to the recording material P in the fixing nip part. The type of recording material P to be fed was Fox River Bond 90 g/m² available from Fox River. The thermistor 15 was TT-K-40 with a wire diameter of 0.08 mm available from Nihon Shintech. The thermistor 15 was arranged at the central position in the widthwise direction (direction perpendicular to the feeding direction of the recording material) apart by 20 mm from the leading edge of the recording material P in the feeding direction.

The heating body 3 of the fixing apparatus used is of two-resistive heating body type. As shown in FIG. 11, a first resistive heating body 6₁ is formed with a width of 1.0 mm at a point apart by 2.0 mm from the upstream edge of the heating body width. A second resistive heating body 62 is formed with a width of 1.5 mm at a point apart by 1.0 mm from the downstream edge of the width of the first resistive heating body 6₁. The distance from the edge of the second resistive heating body to the downstream edge of the heating body width is 1.5 mm. The heating body width Wk is 7 mm, and the fixing nip part width Wn is 6 mm. The resistive heating body width Wt is the sum of the width of the first resistive heating body 6₁ and the width of the second resistive heating body 6₂, and is Wt=2.5 mm. The heating body width Wk and resistive heating body width Wt have a relation: Wt=0.36Wk.

In this specification, downstream is defined as the direction that the recording material moves, while upstream is defined as the opposite of the direction that the recording material moves.

Printing is performed at an input voltage AC of 120 V/60 Hz, a process speed of 70 mm/sec, and room temperature of 23° C./50%. FIG. 12 shows the relation between the position of the recording material P and the application temperature (° C.) of the recording material P at the fixing nip part and in its neighboring region under these conditions.

The temperature of the recording material P rises by about 40° C. to about 60° C. in Zone A before the recording material P reaches the fixing nip part. This is because the film 2 is heated by the heating body 3 to a certain degree and the recording material P is heated by a film part on the upstream side from the fixing nip part before the recording material P reaches the fixing nip part.

In Zone B corresponding to the fixing nip part width Wn, the temperature abruptly rises from about 60° C. to 150° C. This is because Zone B corresponds to the fixing nip part.

In Zone C after the recording material P has passed through the fixing nip part, the temperature gradually decreases from the peak in Zone B.

In order to suppress the heat capacity, the strength of the rotary body cannot be excessively increased in the heating apparatus having such a flexible rotary body. The rotary body must be so designed as not to be destructed.

For example, as shown in FIG. 15, the fixing nip part width Wn is set to 8.0 mm, which is about 1.0 mm larger each on the upstream side and downstream side of the heating body width Wk than the heating body width Wk of 6.0 mm. This makes the heating body width Wk fall within the fixing nip part width Wn (Wk<Wn). In this case, the edge of the substrate of the heating body 3 exists within the fixing nip part. The edge of the heating body substrate scratches the inner surface of the film 2, and the scratched film part becomes thin, decreasing the film strength.

To prevent this, in the prior art, the heating body width Wk is designed larger than the fixing nip part width Wn so as to make the substrate edge fall outside the fixing nip part, as shown in FIGS. 11 and 12. With this arrangement (Wk>Wn), the inner surface of the film is not strongly pressed against the substrate edge, and wear of the inner surface of the film can be suppressed.

If, however, the substrate width is larger than the nip width, the substrate has a part within the nip and a part outside the nip. Heat from the part within the nip is conducted to the pressure roller via the rotary body. Heat from the part outside the nip is conducted not to the pressure roller but only to the rotary body. The temperature gradient appears in the substrate, and makes the substrate readily crack.

In addition, a toner image generates a smeared image trailing edge depending on the transition of the temperature rise of the recording material when the recording material passes through the nip.

The smeared image trailing edge is generated in the image ta heated and fixed by introducing, into the fixing nip part, the recording material P bearing the unfixed toner image t, and clamping and conveying the recording material P. The smeared image trailing edges are scattered image parts tb like trails generated toward the trailing edge of the recording material, as shown in FIG. 13.

Attention is given to a temperature profile at 100° C. at which water also contained in the recording material P evaporates in the use of the above-described fixing apparatus. The temperature gradually rises in the first half of Zone B in FIG. 12, reaches about 100° C. at a timing of about 0.28 sec along the lower time scale (sec), and peaks at 0.34 sec.

The toner state on the recording material in this state is shown. As shown in FIG. 14A, in Zone A, the unfixed toner image t on the recording material slightly raises its temperature due to a small amount of heat accumulated in the film 2 and a small amount of heat accumulated on the upstream side of the heating body. The toner of the toner image t hardly melts.

In Zone B, the toner image t on the recording material P gradually melts from the surface side to the center, as shown in FIG. 14B, and completely melts at 0.34 sec, as shown in FIG. 14C. At the same time, the molten toner image t on the recording material P is gradually flattened from above the recording material P by the fixing pressure force.

The smeared image trailing edge tb of the image is generated while the toner image t is flattened. That is, the smeared image trailing edge is generated in the state “the surface of the toner image melts slightly=the center is in a powder state=the attraction between toner particles is small” in FIG. 14B and the step of “gradually flattening the toner image from above the recording material.” While the surface of the toner image melts slightly, the pressure force is gradually applied. When the temperature in the fixing nip part exceeds 100° C., water in the recording material P evaporates, and water vapor starts expanding. Expanded water vapor squeezes the toner from the toner image and scatters the toner to the trailing edge of the image.

In the image heating apparatus using a flexible rotary body (e.g., a film), the durability of the rotary body and heater must be ensured, and generation of the smeared image trailing edge of the toner image must be prevented.

### SUMMARY OF THE INVENTION

The present invention has been made to overcome the conventional drawbacks, and has as its object to provide an image heating apparatus capable of suppressing a decrease in durability of a flexible rotary body.

It is another object of the present invention to provide an image heating apparatus capable of suppressing a decrease in durability of a heater.

It is another object of the present invention to provide an image heating apparatus capable of suppressing generation of the smeared image trailing edge of an image.

It is further object of the present invention to provide an image heating apparatus comprising:

a sliding member;

a supporting member which holds the sliding member;

a pressure member which forms a nip part for clamping and conveying a recording material in cooperation with the sliding member; and

a flexible rotary body which rotates while being sandwiched at the nip part,

wherein an area of the nip part extends from an area defined by the sliding member and the pressure member to an area defined by the pressure member and the supporting member on an upstream side of the rotary body in a rotational direction, and

a portion of the supporting member that forms the nip part projects from a surface of the sliding member on the nip part side.

It is still further object of the present invention to provide an image heating apparatus comprising:

a heating member, the heating member having a substrate and a heat generating resistor formed on the substrate;

a supporting member which holds the heating member;

a flexible rotary body which rotates in contact with the heating member; and

a pressure member which forms a nip part for clamping and conveying a recording material in cooperation with the heating member and the supporting member,

wherein a width Wn of the nip part in a moving direction of the recording material is larger than a width Wk of the heating member, and a width Wt of the heat generating resistor satisfies Wk×0.5≦Wt<Wk.

The above and other objects, features, and advantages of the present invention will be apparent from the following detailed description of the preferred embodiments in conjunction with the accompanying drawings.

### BRIEF DESCRIPTION OF THE DRAWINGS

FIG. 1 is an enlarged sectional view showing a nip part and its neighborhood in a fixing apparatus (heating apparatus) according to Embodiment 1;

FIG. 2 is a graph showing the comparison in the transition of the recording material surface temperature between a fixing nip part, the preceding zone, and the succeeding zone in the fixing apparatus of Embodiment 1 and a conventional fixing apparatus;

FIGS. 3A and 3B are views for explaining the angle of the edge of a heating body for preventing damage to a film;

FIG. 4 is an enlarged sectional view showing a nip part and its neighborhood in a fixing apparatus according to Embodiment 2;

FIG. 5 is a graph showing the comparison in the transition of the recording material surface temperature between a fixing nip part, the preceding zone, and the succeeding zone in the fixing apparatus of Embodiment 2 and the fixing apparatus of Embodiment 1;

FIG. 6 is a schematic view showing an arrangement of an image forming apparatus which can incorporate an image heating apparatus according to the present invention;

FIG. 7 is a schematic view showing an arrangement of a film heating type fixing apparatus (heating apparatus);

FIG. 8 is an enlarged sectional view showing a nip part and its neighborhood in the fixing apparatus of FIG. 7;

FIG. 9 is a graph showing an output from a thermistor as a heating body temperature detection element upon fixing;

FIG. 10 is a graph showing a thermistor used to measure the transition of the recording material surface temperature in the fixing nip part, the preceding zone, and the succeeding zone, and also showing the attaching position on the recording material;

FIG. 11 is an enlarged sectional view showing a nip part and its neighborhood in a fixing apparatus using a two-resistive heating body type heating body;

FIG. 12 is a graph showing the transition of the recording material surface temperature in the fixing nip part, the preceding zone, and the succeeding zone in the fixing apparatus of FIG. 11;

FIG. 13 is a view for explaining an image error (smeared image);

FIGS. 14A, 14B and 14C are views for explaining a process from the start of heating and melting an unfixed toner image to fixing of the toner image; and

FIG. 15 is an enlarged sectional view showing a nip part and its neighborhood in a fixing apparatus' in which the fixing nip part width is larger than the heating body width.

### DETAILED DESCRIPTION OF THE PREFERRED EMBODIMENTS

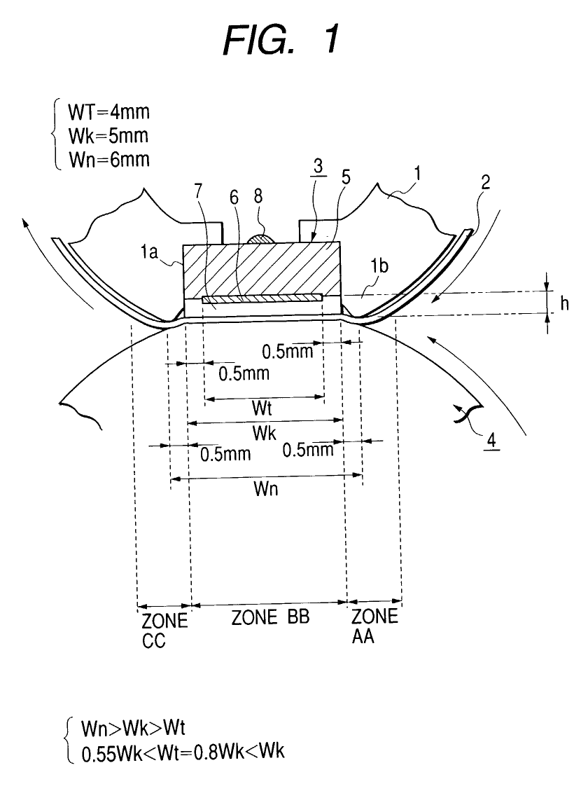

Embodiment 1 (FIGS. 1, 2, 3A and 3B)

A fixing apparatus according to Embodiment 1 is basically the same as the conventional fixing apparatus described above. This fixing apparatus is a pressure roller-driven film heating type fixing apparatus using a cylindrical film.

FIG. 1 is a schematic cross-sectional view showing the arrangement of a heating body (sliding member) 3 and a fixing nip part in the fixing apparatus of Embodiment 1. In the fixing apparatus of Embodiment 1, the fixing nip part width Wn is 6.0 mm, similar to the prior art, and the heating body width Wk is 5.0 mm. The position and size of the heating body width Wk with respect to the fixing nip part width Wn are as follows: the upstream edge of the heating body width starts 0.5 mm inward from the upstream edge of the fixing nip part width, and the heating body width reaches 0.5 mm inward from the downstream edge of the fixing nip part width. Further, the position and size of the width Wt of a resistive heating body 6 serving as the heating member of the heating body 3 with respect to the heating body width Wk are as follows: the upstream edge of the resistive heating body width starts 0.5 mm inward from the upstream edge of the heating body width, and the resistive heating body width reaches 0.5 mm inward from the downstream edge of the heating body width. In other words, the width Wt of the resistive heating body 6 is 4.0 mm and set to

Wn>Wk>Wt

The heating body width Wk and resistive heating body width Wt are set to satisfy

0.50×Wk<Wt<Wk

more preferably,

0.55×Wk<Wt<Wk

As for the heating body 3, resistive heating body 6, and fixing nip part of the conventional fixing apparatus, as shown in FIGS. 8, 11 and 12, the heating body width Wk is larger than the fixing nip part width Wn:

Wn<Wk

(1) Prevention of Smeared Image Trailing Edge

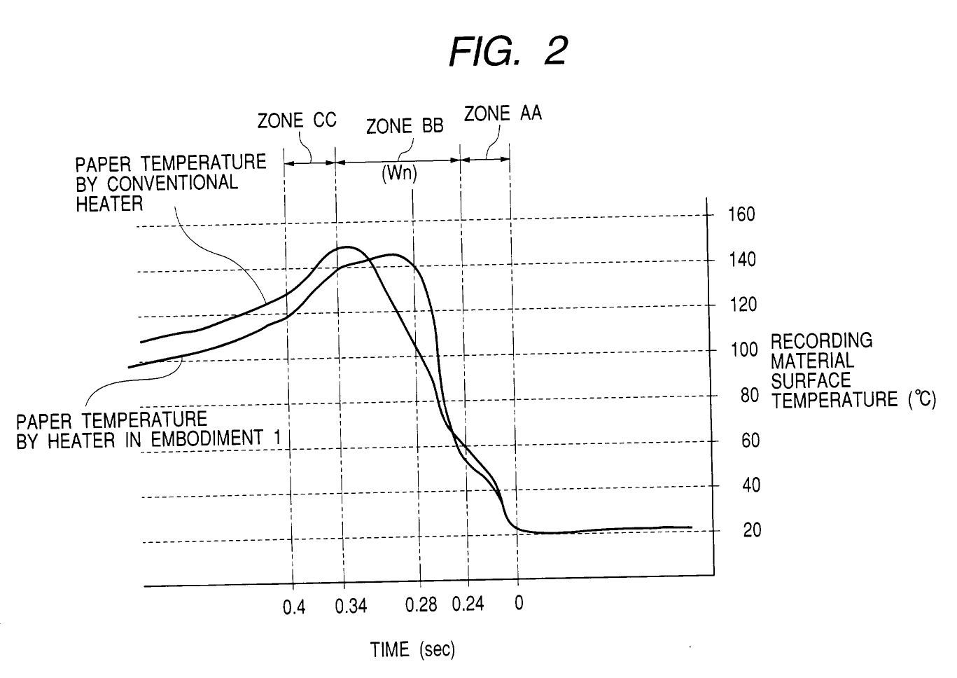

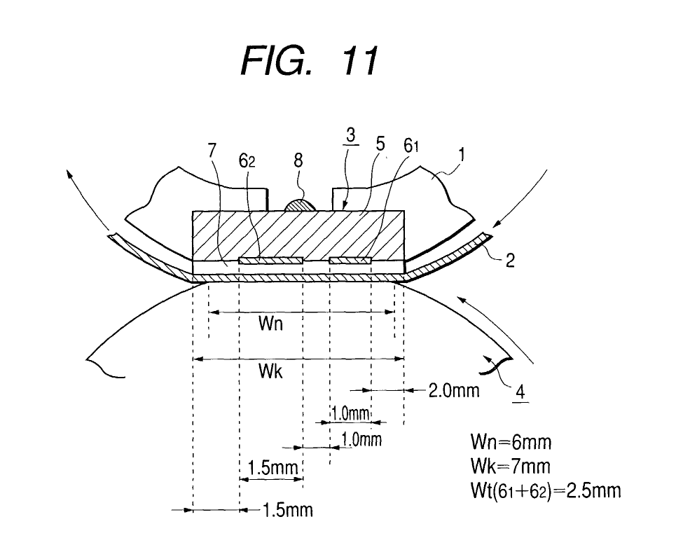

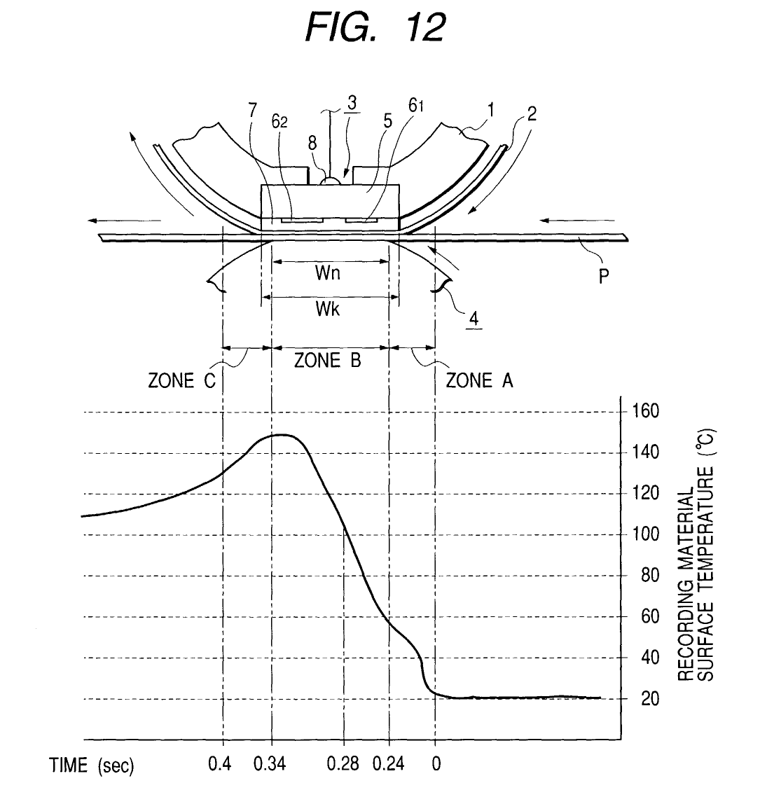

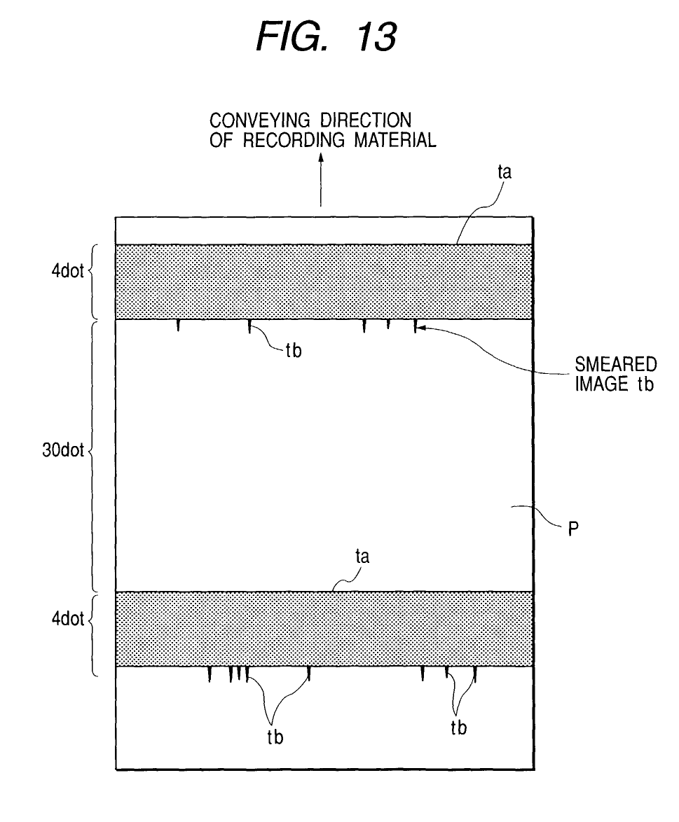

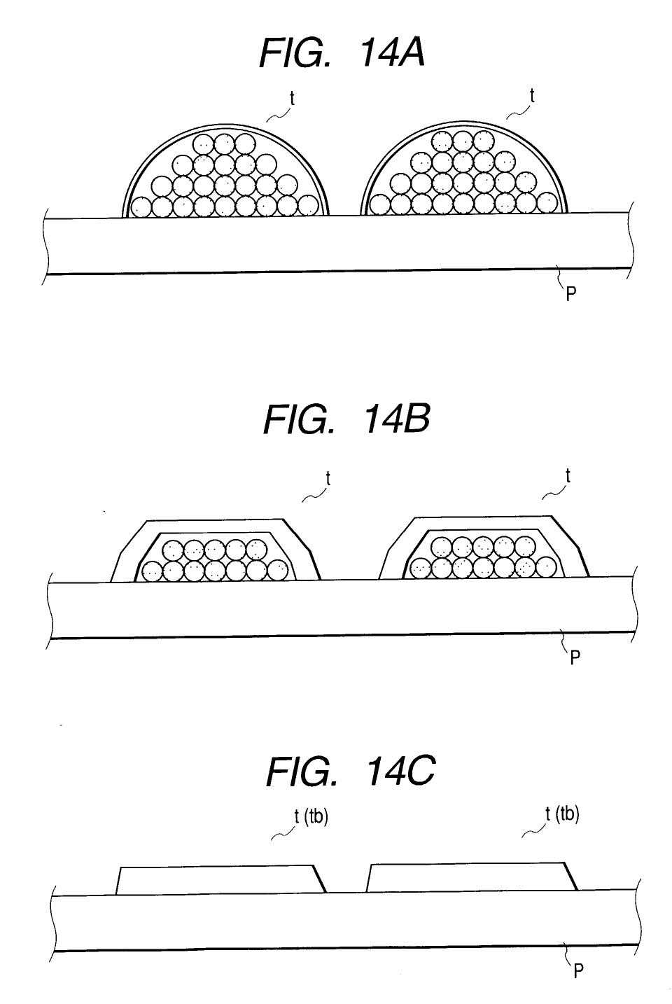

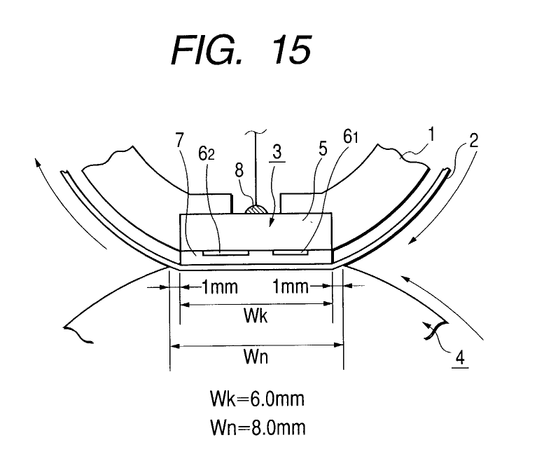

A recording material was fed through the fixing apparatus of Embodiment 1, and the surface temperature (heating body side) of the recording material was monitored. The temperature at that time is shown in FIG. 2 together with that of the conventional fixing apparatus in FIGS. 11 and 12. Zone AA, Zone BB, and Zone CC in FIG. 2 have almost the same relationship as that of the conventional fixing apparatus, and are an upstream region from the nip part formed by the heating body and pressure member, the region of the nip part formed by the heating body and pressure member, and a downstream region from the nip part formed by the heating body and pressure member. The apparatus shown in FIG. 1 is different from the apparatus shown in FIG. 12 in that the nip part is formed not only by the heating body 3 and a pressure member 4 but by the pressure member 4 and a holding member 1 which holds the heating body 3, that is, the area of the nip part extends from an area defined by the heating body (sliding member) and pressure member to an area defined by the pressure member and the holding member on the upstream side in the rotational direction of the rotary body. In Embodiment 1, the nip part includes not only the area defined by the pressure member and the holding member on the upstream side in the rotational direction of the rotary body from the nip part formed by the heating body and pressure member, but also a downstream area. At least the upstream side suffices to form the nip part.

In Zone AA, the temperature rises while keeping a slightly low temperature state, similar to the conventional fixing apparatus. This is because the heating body width Wk is smaller than the fixing nip part width Wn and the amount of heat conducted from the heating body itself is small. The temperature is about 58° C. on the last stage of Zone AA (boundary between Zone AA and Zone BB).

In Zone BB, the temperature rises differently from that of the conventional fixing apparatus because the resistive heating body 6 extends close to the boundary between Zone AA and Zone BB. The temperature rise is steeper than that of the conventional fixing apparatus. The temperature is higher by about 20° C. than that of the conventional fixing apparatus upon the lapse of 0.28 sec along the lower time scale (sec) in FIG. 2.

On the last stage (immediately before Zone CC) of Zone BB, the temperature is lower by about 5° C. than that of the conventional fixing apparatus. This is because steep temperature rise is exhibited on the initial stage of Zone BB and the controlled temperature is suppressed low in order to adjust the heat amount to be conducted to the recording material (heat amount for ensuring fixation) to a predetermined value.

The state of the toner image t will be described. In Zone AA, the temperature is almost the same as that of the conventional fixing apparatus. The surface of the toner image t slightly absorbs heat and melts, similar to the conventional fixing apparatus.

In Zone BB, the temperature in the fixing nip part width Wn steeply rises. Heat is conducted from the surface of the toner image t to almost all the interior thereof, and half or more of the toner image t melts. In this state, heat from the heating body 3 is conducted to the recording material itself. Similar to the conventional fixing apparatus, water in the recording material evaporates to generate a smeared image trailing edge. In the fixing apparatus of Embodiment 1, steep temperature rise in the fixing nip part width Wn melts the toner image more than the conventional toner image. The viscosity at the molten part increases the attraction between toner particles, preventing toner scattering (smeared image trailing edge) by water vapor, unlike the conventional fixing apparatus.

In Zone CC, the temperature exhibits almost the same decrease as that of the conventional fixing apparatus from the peak temperature in Zone BB. The temperature assists melting of the toner image t to fix the toner image onto the recording material P.

It has been turned out to be able to suppress the smeared image trailing edge of an image by setting the temperature rise transition of a recording material to a temperature profile as shown in FIG. 2. It has experimentally been found that, to form the temperature profile, the fixing nip part width Wn is set larger than the width Wk of a substrate 5 and the width Wt of the resistive heating body 6 and the width Wk of the substrate 5 satisfy

Wk×0.50≦Wt<Wk

(2) Prevention of Heater Cracking

Prevention of heater cracking will be described. This will be briefly explained using the heating body shape, resistive heating body shape, and nip shape. In this state (FIG. 1), both the heating body 3 and resistive heating body 6 are housed in the fixing nip part width Wn, and no abnormal temperature rise of the heating body itself occurs. In other words, the resistive heating body 6 does not protrude from the fixing nip part width Wn, no thermal stress occurs in the heating body 3, and no destruction occurs.

Further, setting a large width Wt of the resistive heating body 6 minimizes the difference in temperature distribution inside the heating body 3.

(3) Prevention of Damage to Film

To solve another conventional problem: film damage (break), as shown in FIG. 1, at least a part of an upstream portion 1b corresponding to a height h in a heating body fitting slot 1a of a heating body supporting member (film guide) 1 which supports the heating body 3 is so chamfered (a convex shape) as not to scratch the inner surface of the film 2 at the substrate edge of the heating body 3. With this structure, the sliding film 2 does not directly come into contact with the edge of the heating body 3, preventing damage to the film 2.

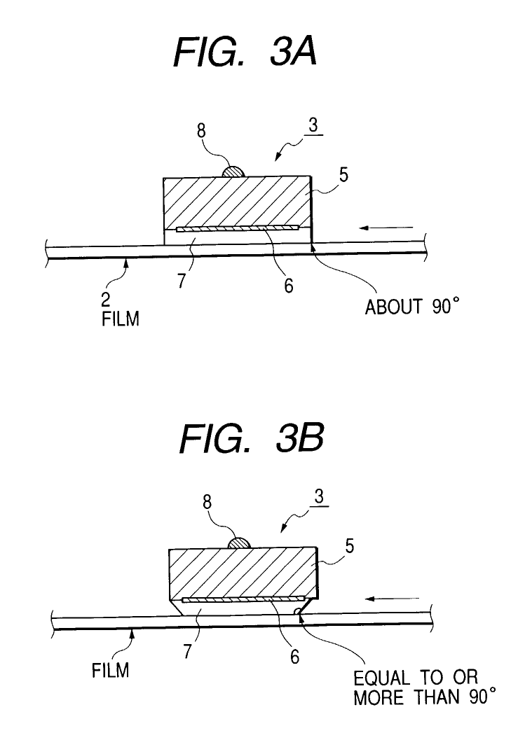

As shown in FIGS. 3A and 3B, the angle at the edge of the heating body 3 is set to 90° or more. This can improve the slidableness of the film 2 and avoid the risk of shaving the inner surface of the film 2. This shape allows relatively roughly designing the relationship in height between the heating body 3 and the heating body supporting member 1 and also provides mechanical arrangement/manufacturing merits.

(4) Improvement of Fixation and Power

Consumption/Controlled Temperature

Improvement of fixation and the power consumption/controlled temperature will be described.

As for fixation, the fixing temperature was determined by the arrangements of the conventional fixing apparatus (FIGS. 11 and 12) and the fixing apparatus of Embodiment 1 under the following conditions. The conditions were a low-temperature environment (10° C./15%), a resistance value of 20 Ω in the resistive heating body 6, an input voltage of 120 V/60 Hz, and a process speed of 70 mm/sec. An evaluation paper sheet used to evaluate fixation was Fox River Bond 90 g/m² available from Fox River. At the four corners of this recording material on the upstream and downstream sides along the feeding direction, 5×5-mm solid black images were printed. Images were printed on 10 paper sheets from a state in which the fixing apparatus was cool.

Fixation was evaluated for printed images on the first, fifth, and 10th paper sheets.

As the evaluation method, five paper sheets SILBON-C available from Toyobo are stacked. The rough surface (slightly roughed surface) is brought into contact with the image surface. A weight of 1.96 N is applied to the stack, and reciprocated five times on a 5-mm-square image to be evaluated to rub the paper sheet. A decrease in density before and after rubbing is measured.

Using this method, the controlled fixing temperature which satisfied fixation in the conventional fixing apparatus and the fixing apparatus of Embodiment 1 was determined.

The controlled fixing temperature was 190° C. after the conventional fixing apparatus was activated in the morning when the apparatus was cool. In the fixing apparatus of Embodiment 1, the controlled fixing temperature was 180° C. which is lower by about 10° C. than in the conventional fixing apparatus.

As described in the effect (1) of preventing a smeared image trailing edge, the temperature distribution in the fixing nip part width Wn in the conveying direction of the recording material can maintain a flat distribution at a relatively high temperature. At this time, the controlled temperature necessary for fixation can be decreased, and thus power consumption is small. By decreasing the controlled fixing temperature, low-heat-resistant materials can be used for, e.g., the sliding grease applied between the heating body supporting member (film guide) 1, the film 2, and the heating body 3 in the fixing apparatus, and an electrical wire bundle for supplying power to the resistive heating body 6. Furthermore, the heat-resistant temperature of the pressure roller 4 for forming a fixing nip part can be decreased. Low-cost materials can be used, and materials can be shared between other components.

A measure against heater cracking will be explained based on Table 1. In Table 1, the upper column shows the occupation ratio (%) of the width Wt of the resistive heating body 6 to the heating body width Wk, and the lower column shows categorized thermal stress risks generated in the heating body 3.

TABLE 1

| | | | | | | | | | | |
|---|---|---|---|---|---|---|---|---|---|---|
| Occupation | 20 | 30 | 40 | 45 | 50 | 55 | 60 | 70 | 80 | 90 |
| Ratio (%) of | | | | | | | | | | |
| Resistive | | | | | | | | | | |
| Heating Body | | | | | | | | | | |
| to Heating | | | | | | | | | | |
| Body | | | | | | | | | | |
| Risk | Δ | ◯ | ◯ | ◯ | ◯ | ⊚ | ⊚ | ⊚ | ⊚ | ⊚ |
| ↑ | ↑ | ↑ | | | | | | | | |

| | | | |
|---|---|---|---|
| | | (Embodiment | (Embodiment |
| | Prior Art | 2) | 1) |
| Thermal Stress | Δ (median | ◯ (low | ⊚ (minimum |
| Risk | risk) | risk) | risk) |
| Determination | 9.8 × 10⁷ | 1.7 to 9.8 × | 1.7 × 10⁷ |
| Stress Limit | or more | 10⁷ | or more |
| (1.77 × E\hat{ }8N/m²) | | | |

In the conventional fixing apparatus, the occupation ratio is 40%, and the thermal stress is ◯. “◯” represents low risk from the table below Table 1. The risk is low when the thermal stress generated in the heating body 3 is 1.7 to 9.8×10⁷, which is lower than a thermal stress limit of 1.77×10⁸ in the heating body 3. Thus, the thermal stress falls within the safety zone.

In the fixing apparatus of Embodiment 1, the occupation ratio is 80%, and the risk is ⊚, that is, the generated thermal stress is 1.7×10⁷ or less.

As for heater cracking, the thermal stress generated in the heating body 3 becomes lower as the width Wt of the resistive heating body 6 is larger than the width Wk of the heating body 3. As long as the occupation ratio in Table 1 is 55% or more, heat from the resistive heating body 6 is easily conducted to the edge of the heating body 3, suppressing generation of the thermal stress.

The fixing apparatus of Embodiment 1 solves the above-described problems and increases the reliability, compared to the conventional fixing apparatus. Fixation can be improved by designing a large resistive heating body 6 while decreasing the width Wk of the heating body 3. In addition, power consumption can be reduced. Decreasing the width Wk of the heating body 3 leads to a small-size apparatus.

By adding the relationship between the heating body 3 and the heating body supporting member 1 which supports the heating body, high durability, long service life, high reliability, and high image quality can be achieved.

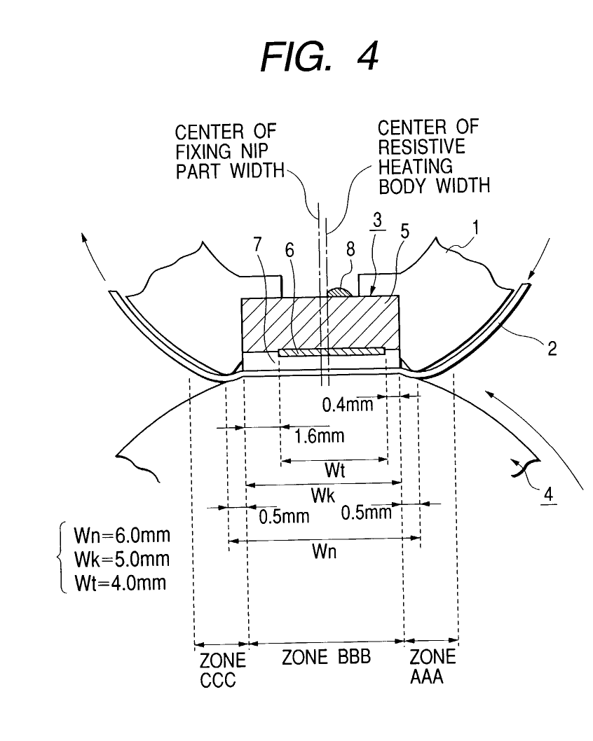

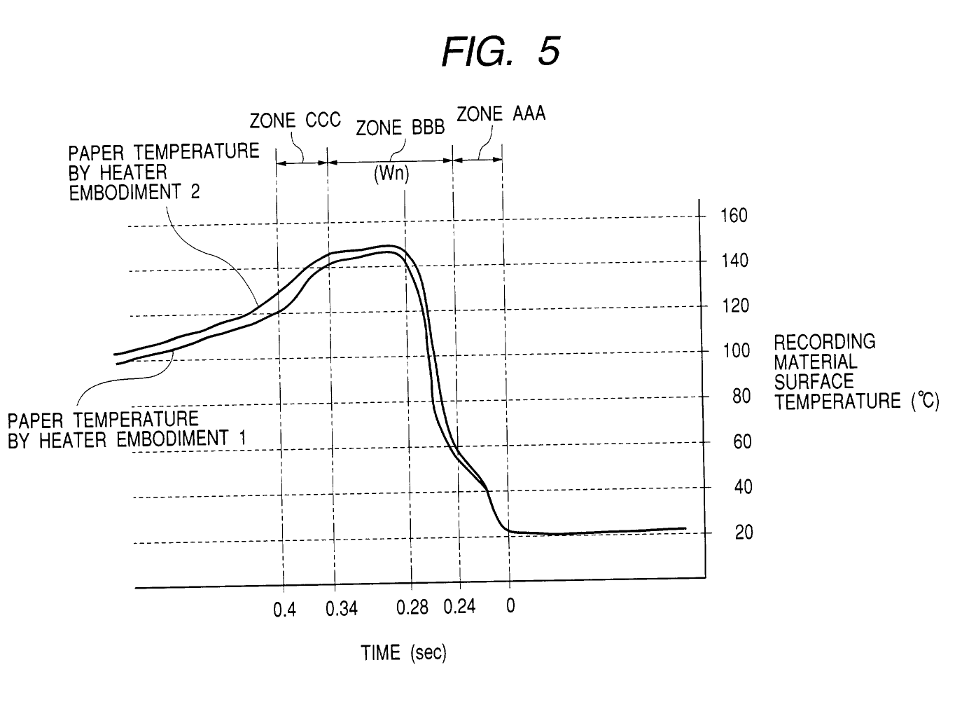

As described above, the nip part width is set larger than the heating body width, and a portion of the heating body supporting member that forms the nip part projects from the nip-side surface of the heating body. This structure can improve the heating body durability and the film durability. The smeared image trailing edge of an image and cracking of the heating body can be prevented by setting the occupation ratio of the resistive heating body in the heating body in the moving direction of the recording material to 50% or more and preferably 55% or more. Embodiment 2 (FIGS. 4 and 5)

In Embodiment 2, similar to Embodiment 1, the heating body width Wk is smaller than the fixing nip part width Wn. Moreover, the central position of the resistive heating body width Wt is located on the upstream side from the center of the fixing nip part width Wn.

This state is shown in FIG. 4. In FIG. 4, the fixing nip part width Wn is 6.0 mm, similar to the prior art, and the heating body width Wk is 5.0 mm. The upstream edge of the heating body width Wk with respect to the fixing nip part width Wn starts 0.5 mm inward from the upstream edge of the fixing nip part width Wn, and the heating body width Wk reaches 0.5 mm inward from the downstream edge of the fixing nip part width Wn.

The width Wt of a resistive heating body 6 starts 0.4 mm inward from the upstream edge of the heating body width Wk, and reaches 1.6 mm inward from the downstream edge of the heating body width Wk. That is, the width Wt of the resistive heating body 6 is 3.0 mm and maintains

Wn>Wk>Wt

Further, Wk=5 mm, Wt=4 mm, and 0.6Wk=Wt holds.

A recording material was fed through a fixing apparatus, and the recording material surface temperature was monitored. The temperature at that time is shown in FIG. 5 together with that of the fixing apparatus in Embodiment 1 (FIG. 2).

In Zone AAA, the temperature is almost the same as that of the fixing apparatus of Embodiment 1. In Zone BBB, the temperature rises differently from those of the conventional fixing apparatus and the fixing apparatus of Embodiment 1 because the resistive heating body 6 exists subsequently to the nip. The temperature rise is steeper than that of the fixing apparatus of Embodiment 1. The temperature is higher by about 5° C. than that of the fixing apparatus of Embodiment 1 upon the lapse of 0.28 sec along the lower time scale in FIG. 5.

On the last stage (immediately before Zone CCC) of Zone BBB, the temperature is higher by about 3° C. than that of the fixing apparatus of Embodiment 1. This is because the width of the resistive heating body 6 is smaller than that of the fixing apparatus of Embodiment 1, and the controlled temperature is set higher in order to adjust the heat amount to be conducted to the recording material (heat amount for ensuring fixation) to a predetermined value. This is apparent from the temperature upon the lapse of 0.28 sec in FIG. 5.

The toner state is almost the same as in the fixing apparatus of Embodiment 1, and a description thereof will be omitted.

In Zone CCC, the temperature exhibits almost the same decrease as that of the fixing apparatus of Embodiment 1 from the peak temperature in Zone BBB. The temperature assists melting of the toner to fix the toner onto the recording material. However, the melting state of the toner in Zone BBB is slightly different from that of the fixing apparatus of Embodiment 1. The temperature rises more steeply, and the peak temperature is higher than that of the fixing apparatus of Embodiment 1. For this reason, the toner melts much more than in Embodiment 1, further suppressing generation of a smeared image trailing edge.

Heater cracking will be described. The resistive heating body 6 in a heating body 3 is shifted to the upstream side due to the heating body shape, resistive heating body shape, and nip shape adopted in Embodiment 2. Heat shifts to the downstream side by adding rotation of a pressure roller 4 and rotation of a film 2. The peak of the temperature distribution of the heating body itself is located at the central position of the heating body width Wk. The thermal stress is also distributed to the upstream and downstream sides of the heating body 3. The thermal stress does not occur on one side, and can shift to a more safety side than in the fixing apparatus of Embodiment 1. The shift to the safety side can improve the reliability for the user who uses the apparatus.

Improvement of fixation and the power consumption/controlled temperature will be described. Fixation was evaluated by the fixation evaluation method described in Embodiment 1, and the controlled fixing temperature was determined with the arrangement of the fixing apparatus of Embodiment 2. In the arrangement of Embodiment 2, the temperature in the morning was 185° C., which is about 5° C. lower than that in the arrangement of the conventional fixing apparatus. Since the controlled temperature is lower than that of the conventional fixing apparatus, power consumption is also smaller, similar to the fixing apparatus of Embodiment 1.

Embodiment 2 exhibits the same effects as those of Embodiment 1 or better effects, unlike the prior art, and can further increase the reliability.

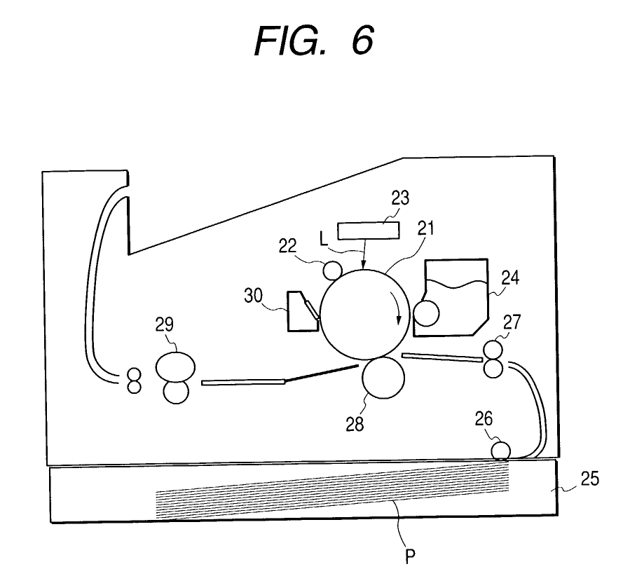

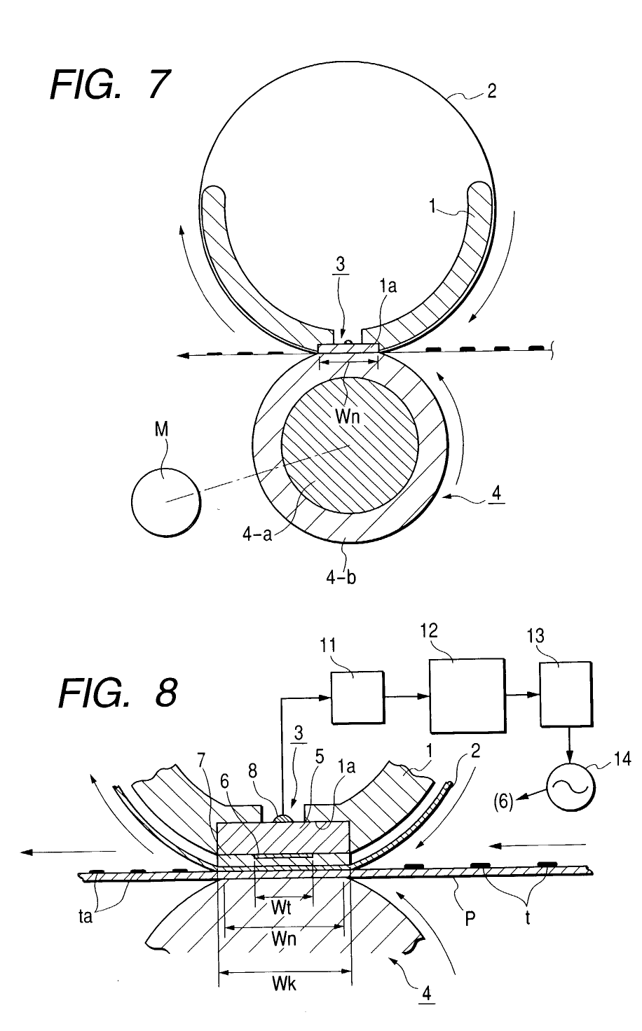

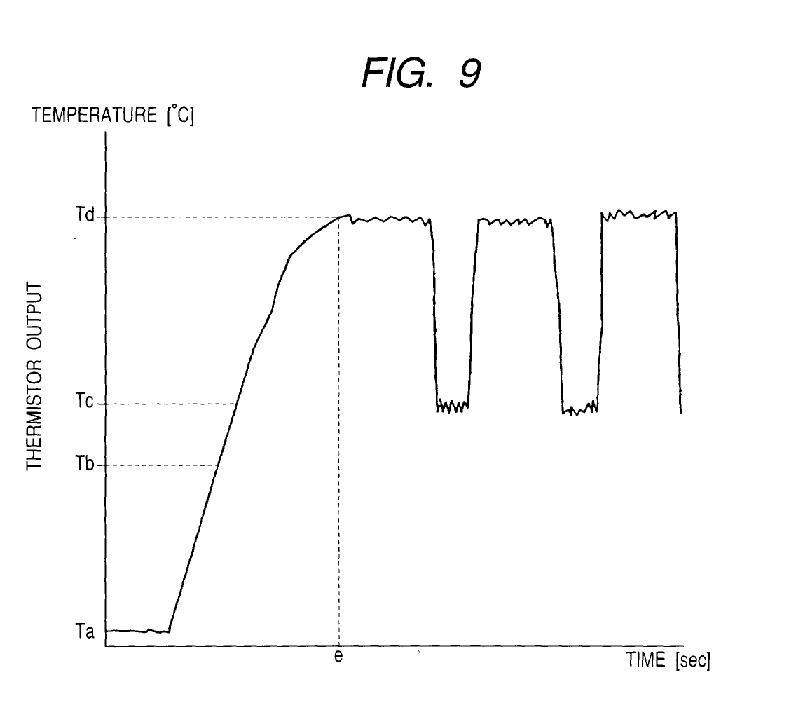

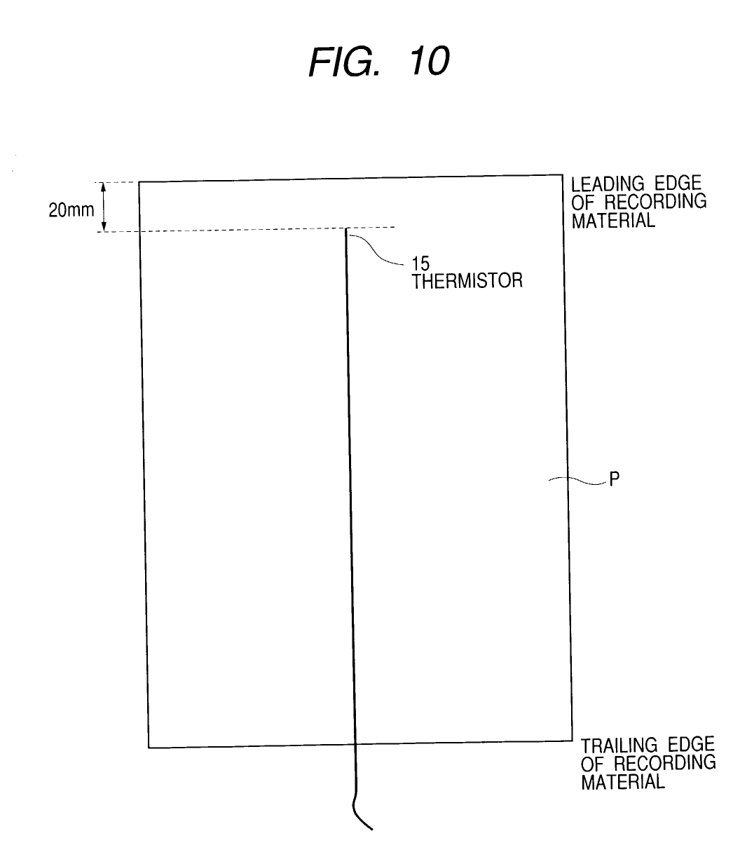

FIG. 6 is a schematic view showing an arrangement of an image forming apparatus which incorporates the fixing apparatus of Embodiment 1 or Embodiment 2. This image forming apparatus is a laser beam printer using a transfer electrophotographic process.

A rotary drum type electrophotographic photosensitive body (to be referred to as a photosensitive drum hereinafter) 21 serving as an image bearing body is rotated and driven at a predetermined peripheral velocity clockwise as indicated by the arrow. The photosensitive drum 21 is constituted by applying a photosensitive material such as OPC or amorphous silicon onto a cylindrical substrate of aluminum, nickel, or the like.

The surface of the rotating photosensitive drum 21 is uniformly charged by a charging roller 22 serving as a charging device. In this example, the photosensitive drum 21 is uniformly charged to a predetermined negative potential.

The uniformly charged surface of the rotating photosensitive drum 21 is scanned and exposed with a laser beam L which is output from a laser scanner 23 serving as an image exposure means and ON/OFF-controlled in accordance with image information. An electrostatic latent image corresponding to the image information is formed on the photosensitive drum 21.

The electrostatic latent image is developed (visualized) as a toner image by a developing device 24. As the developing method, a jumping developing method, a two-component developing method, or the like is employed. In many cases, a combination of image exposure and reversal development is used.

A recording material P is picked up by a pickup roller 26 from a cassette 25, and fed to a registration roller 27. The recording material P is synchronized by the registration roller 27 with the toner image formed on the surface of the photosensitive drum 21, and supplied to a transfer nip part formed by the photosensitive drum 21 and a transfer roller 28. Synchronization between the recording material P and the toner image on the surface of the photosensitive drum 21 at the transfer nip part may be performed by a registration sensor.

At the transfer nip part, the toner image on the photosensitive drum 21 is transferred onto the recording material P by a transferring bias voltage from a power supply (not shown).

The recording material P which is separated from the surface of the photosensitive drum 21 and bears the unfixed toner image is conveyed to a heat fixing apparatus 29. The recording material P is heated and pressurized at the fixing nip part of the heat fixing apparatus 29. The toner image is fixed as a permanent image onto the recording material P, and the recording material P is discharged outside the apparatus.

The toner remaining on the photosensitive drum 21 after transfer is removed by a cleaning apparatus 30 from the surface of the photosensitive drum 21.

Other Embodiments

1) The film can be moved and driven by a driving member other than the pressure roller.

2) The pressure member is not limited to the pressure roller and can be a belt member.

3) The heating body can use an electromagnetic induction heating member as a heating member. The present invention can be applied to an electromagnetic induction image heating apparatus in which the heating body in the above-described embodiments functions as merely a sliding member for sliding the film and the film itself generates heat.

4) The heating apparatus of the present invention is not limited to a heat fixing apparatus for an unfixed image, and is also effective as an image heating apparatus for provisionally fixing an image or improving the surface quality such as the image gloss.

The present invention is not limited to the above-described embodiments, and can be variously modified within the spirit and scope of the invention.

What is claimed is:

1. An image heating apparatus for heating an image formed on a recording material, comprising:
a sliding member;
a supporting member for holding said sliding member;
a pressure member which forms a nip part for clamping and conveying the recording material in cooperation with said sliding member; and
a flexible rotary body for rotating while being sandwiched at the nip part,
wherein an area of the nip part extends from an area defined by said sliding member and said pressure member to an area defined by said pressure member and said supporting member on an upstream side of said rotary body in a rotational direction, and
a portion of said supporting member which forms the nip part projects from a surface of said sliding member on the nip part side.

2. An apparatus according to claim 1, wherein an angle of an edge of said sliding member is equal to or more than 90°.

3. An apparatus according to claim 1, wherein said sliding member comprises a substrate and a heat generating resistor formed on said substrate.

4. An image heating apparatus for heating an image formed on a recording material, comprising:
a heating member, said heating member having a substrate and a heat generating resistor formed on said substrate;
a supporting member which holds said heating member;
a flexible rotary body which rotates in contact with said heating member; and
a pressure member which forms a nip part for clamping and conveying the recording material in cooperation with said heating member and said supporting member,
wherein a width Wn of the nip part in a moving direction of the recording material is larger than a width Wk of said heating member, and a width Wt of said heat generating resistor satisfies Wk×0.50≦Wt<Wk.

5. An apparatus according to claim 4, wherein the width Wt of said heat generating resistor further satisfies Wk×0.55≦Wt<Wk.

6. An apparatus according to claim 4, wherein a central position of said heat generating resistor in the moving direction of the recording material is on an upstream side from a central position of said substrate.
